(19) United States
(12) Patent Application Publication
(10) Pub. No.: US 2008/0120206 A1
(43) Pub. Date: May 22, 2008

(54) Stock level management

(75) Inventors: Thomas Weiler, Saarlouis (DE); Michel Feurich, Mehlingen (DE); Martina Wingert, Eppelborn (DE)

Correspondence Address: FOLEY & LARDNER LLP, 111 HUNTINGTON AVENUE, 26TH FLOOR, BOSTON, MA, 02199-7610, US

(73) Assignee: SAP Aktiengesellschaft

(21) Appl. No.: 11/590,192

(22) Filed: Oct. 31, 2006

(51) Int. Cl. G06Q 10/00

(52) U.S. Cl. 705/28

(57) ABSTRACT

A computer-implemented method of managing stock levels. An example method includes the step of obtaining stock level information for a plurality of locations for a first product. A first best seller location is determined for the first product from the plurality of locations. The method further includes the step of displaying the stock level information for the plurality of locations for the first product. A proposed reallocation of stock levels of the first product to the first best seller location from at least one location, other than the first best seller location, of the plurality of locations, is displayed. The method further includes the step of ordering the proposed reallocation of the first product.

### FIELD

The present disclosure generally relates to the field of stock management. The present disclosure relates more specifically to management of stock levels for a plurality of locations.

### BACKGROUND

Stock levels of articles (for example fashion products, other salable products, or any other product capable of being stocked) generally differ between different locations of the same type (e.g. stores, warehouses, etc.). For example, in one store, various items may sell better or slower than they might in a different store owned by the same company. Typically, it may be more profitable to keep a higher stock of an item in a better selling store, so stock of the item does not run out, and a lower stock of an item at a slower selling store. Generally, at a better selling store, the store may order more of an article from another point in the supply chain (e.g. distribution warehouse, manufacturer, etc.) to avoid running out of the article while a slower selling store may continue to stock the article and waste capacity or send the article to another point in the supply chain, such as back to a distribution warehouse. The time of transit for an article being sent from a slow selling store to a warehouse may cause a better seller store to run out of stock while waiting for ordered articles. Thus, there is a need to timely reallocate stock levels between locations to avoid running out of stock.

### SUMMARY

One embodiment of the invention relates to a computer-implemented method of managing stock levels. The method includes the step of obtaining stock level information for a plurality of locations for a first product. A first best seller location is determined for the first product from the plurality of locations and stock level information for the plurality of locations for the first product is displayed. The method also includes the step of displaying a proposed reallocation of stock levels of the first product to the first best seller location from at least one location, other than the first best seller location, of the plurality of locations; the proposed reallocation of the first product is ordered.

Another embodiment of the invention relates to a computer-implemented method of managing stock levels. The method includes the step of obtaining stock level information for a plurality of locations for a first product. A first slow seller location is determined for the first product from the plurality of locations and stock level information for the plurality of locations for the first product is displayed. The method also includes the step of displaying a proposed reallocation of stock levels of the first product to the first slow seller location from at least one location, other than the first slow seller location, of the plurality of locations; the proposed reallocation of the first product is ordered.

Another embodiment of the invention relates to a computer-readable medium for use with an electronic device. The medium has instructions executable using the electronic device for performing a method of managing stock levels. The method includes the step of obtaining stock level information for a plurality of locations for a first product. A first best seller location is determined for the first product from the plurality of locations is determined and the stock level information for the plurality of locations for the first product is displayed. The method also includes the step of displaying a proposed reallocation of stock levels of the first product to the first best seller location from at least one location, other than the first best seller location, of the plurality of locations; the proposed reallocation of the first product is ordered.

Another embodiment of the invention relates to a computer-readable medium for use with an electronic device. The medium has instructions executable using the electronic device for performing a method of managing stock levels. The method includes the step of obtaining stock level information for a plurality of locations for a first product. A first slow seller location is determined for the first product from the plurality of locations is and the stock level information for the plurality of locations for the first product is displayed. The method also includes the step of displaying a proposed reallocation of stock levels of the first product to the first slow seller location from at least one location, other than the first slow seller location, of the plurality of locations; the proposed reallocation of the first product is ordered.

### BRIEF DESCRIPTION OF THE DRAWINGS

FIG. 1 is a schematic view of a stock management system according to one exemplary embodiment.

FIG. 2 is a flow diagram of a method for managing stock levels within the system of FIG. 1 by determining a best seller, according to one exemplary embodiment.

FIG. 3 is a flow diagram of a method for managing stock levels within the system of FIG. 1 by determining a slow seller, according to one exemplary embodiment.

FIG. 4 is a flow diagram of a method for managing stock levels within the system of FIG. 1 by determining a best seller and a slow seller, according to one exemplary embodiment.

FIG. 5 is a chart illustrating a method for moving stock from a best seller location to a slow seller location in the system of FIG. 1, according to one exemplary embodiment.

FIG. 6 is a chart illustrating a method for moving stock from a slow seller location to a best seller location in the system of FIG. 1, according to one exemplary embodiment.

### DETAILED DESCRIPTION OF THE EXEMPLARY EMBODIMENTS

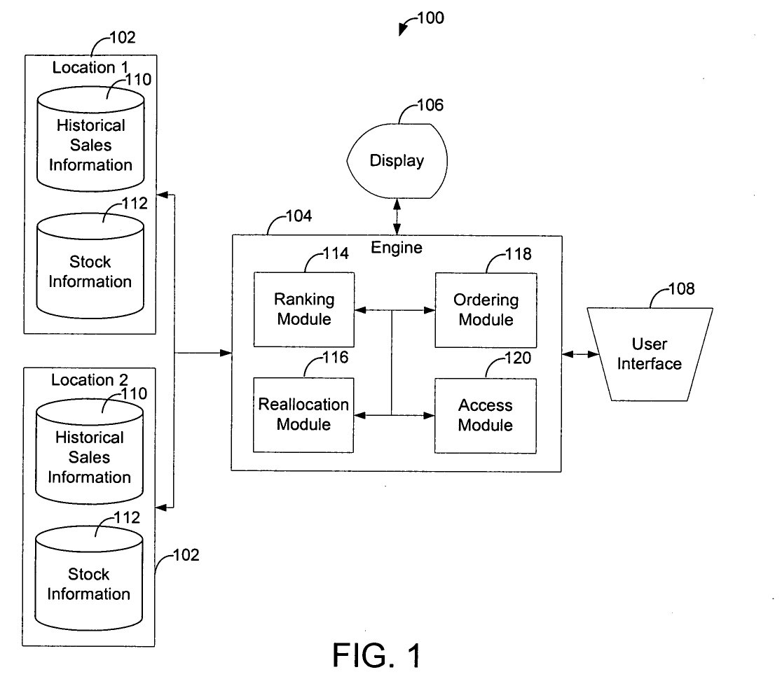

Referring to FIG. 1, an exemplary stock management system 100 is configured to manage stock levels of various locations. In various exemplary embodiments, stock management system 100 may be a hardware (e.g. digital logic of a computer) or a software implementation or a combination thereof. Software implementations are typically provided as a computer program product that contains computer-readable code stored on a computer-readable medium for use by a computer. Hardware implementations may be provided using digital logic circuitry, analog circuitry, a combination thereof, or any other past, present, or future hardware technology. Stock management system 100 generally includes one or more locations 102, an engine 104, a display 106, and a user interface 108.

Location 102 is typically any location that is capable of storing or creating historical sales information and/or stock information, for example a retail store, a distribution warehouse, a wholesale distributor, etc. In the illustrated embodiment, locations 102 may store historical sales information 110 and stock information 112 in local databases. According to one exemplary embodiment where there are multiple locations 102, each location may be of the same type (e.g. each being a retail store), while in other embodiments, locations 102 may be of different types. In various exemplary embodiments, historical sales information 110 may be any information related to past sales of an article or product at a location, for example the amount of a clothing article sold in a retail store, while stock information 112 may be any information related to the amount of an article or product at hand at a location, for example the amount of a clothing article currently in stock at a retail store. It is noted that while the illustration shows historical sales information 110 and stock information 112 as being stored in a database local to location 102, in other exemplary embodiments, the data may only be created at location 102 and stored at another location, for example proximate to engine 104.

Engine 104 is configured to manage the stock levels of location 102. In one exemplary embodiment, engine 104 may be located substantially centrally, such as on one or more servers, and accessed by locations across a network such as the Internet, a LAN, a WAN, etc. In another exemplary embodiment, engine 104 may be decentralized with the logic being located, either in software or hardware, at each location. Engine 104 generally includes a ranking module 114, a reallocation module 116, an ordering module 118, and an access module 120. It is understood that the engine 104 may be employed by the use of a different module structure than that illustrated and that one or more modules may be located on one or more servers and/or networks.

Ranking module 114 is configured to determine best and/or slow seller locations for a product based on multiple locations, such as locations 102. For purposes of this disclosure, a “best seller location,” may be defined as a location that is involved with the sale of an amount of a product that is greater than the sales amount of a product that another location is involved with. For purposes of this disclosure, a “slow seller location,” may be defined as a location that is involved with the sale of an amount of a product that is less than the sales amount of a product that another location is involved with. As used herein, a “product” may refer to any item associated with stock level information. In one example, a product may refer to a specific size and color configuration of an item. In another non-limiting example, a stock keeping unit (SKU) identifier may be assigned to each product.

According to one exemplary embodiment, ranking module 114 may determine a best or slow seller by obtaining historical sales information for a plurality of locations. For example, by comparing historical sales information 110 for locations 102, ranking module 114 may determine that one of locations 102 is a best or slow seller location. According to another exemplary embodiment, ranking module 114 may determine a best or slow seller by comparing previous stock level information for a plurality of locations to more recent stock level information for the plurality of locations. For example, ranking module 114 may compare previous stock level information from stock information 112 with current stock level information from stock information 112 for locations 102.

Reallocation module 116 is configured to propose a reallocation of stock levels of a product from a first location to one or more other locations other than the first location, for example between locations 102, based on best and/or slow seller determinations made by ranking module 114. Reallocation module 116 may propose a reallocation of a product from a slow seller to a best seller, a product from a best seller to a slow seller, or both. Reallocation module 116 may determine the specific amount of a product proposed for reallocation.

Ordering module 118 is configured to order a proposed reallocation of a product from one location to one or more other locations. The proposed reallocation from reallocation module 116 may be modified and/or confirmed by a user via user interface 108 or remotely from one of locations 102. Once ordering module 118 places an order, the proposed reallocation from reallocation module 116, including any modifications made by a user, is ordered.

Access module 120 is configured to control access rights that various locations have to proposed reallocations created by reallocation module 116. In various exemplary embodiments, access rights may include read access, write access (e.g. enabling modifications), copy access, or any other rights an administrator of engine 104 may wish to restrict. For example, access module 120 may restrict or prevent a particular retail store from the act of enabling modifications to a proposed reallocation of a product. Conversely, access module 120 may enable modifications to a proposed reallocation of stock levels. According to another example, access module 120 may restrict access of a retail store to view display information.

Display 106 is configured to give a visual output from engine 104 to a user. According to one exemplary embodiment, display 106 may give information relating to proposed reallocation of stock levels of a product, stock level information, or any other information that may be available to engine 104. In various examples, display 106 may be a cathode-ray-tube (CRT) display, liquid crystal display (LCD), plasma display, digital light processing (DLP) display, or any other past, present, or future display technology.

User interface 108 is configured to provide a user with access to engine 104. As discussed previously, for example, a user may make modifications to a proposed reallocation of stock levels. A user may wish to view stock level information, sales information, reallocation information, or any other pertinent information on display 106 and may manipulate user interface 108 to make such selections. According to various exemplary embodiments, user interface 108 may be of any past, present, or future design and may include one or more of a tactile touch screen on display 106, a knob, a pushbutton, a directional controller, a lever, voice activation, any other means of control, or any combination thereof. User interface 108 may also include a computer-readable media drive to facilitate software updates; uploading of stock, sales, or reallocation information; or other functions loadable from a computer readable medium.

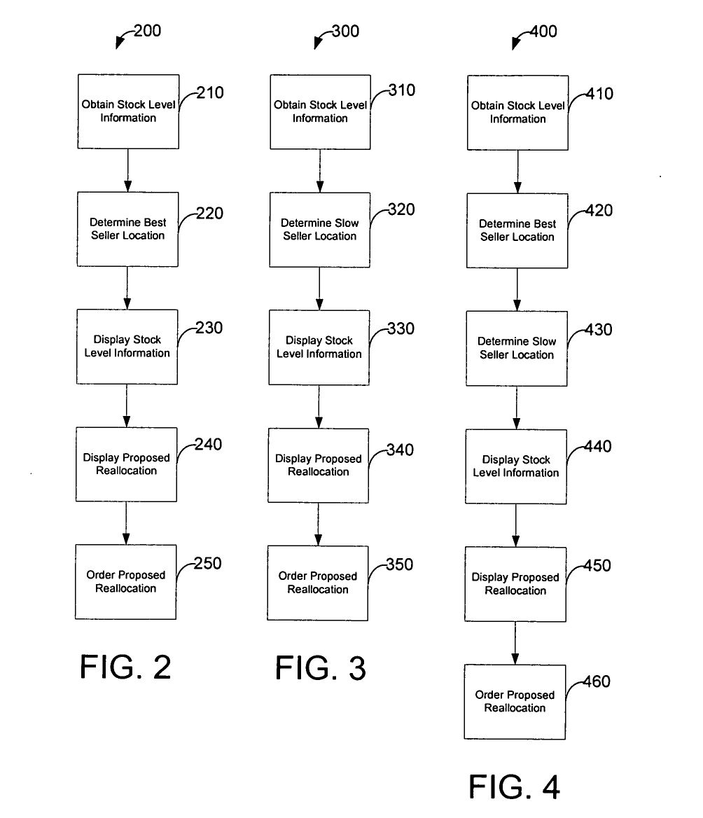

Referring to FIG. 2, a method 200, according to one exemplary embodiment, for performing a reallocation based on a best seller location is illustrated. A stock level information for a plurality of locations for a first product is obtained at step 210. For example, engine 104 may retrieve stock information 112 from locations 102.

A first best seller location for the first product from the plurality of locations is determined at step 220. For example, ranking module 114 may determine a best seller location between locations 102 based on received historical sales information 110 from locations 102.

The received stock level information is displayed for the plurality of locations for the first product at step 230. For example, engine 104 may send received stock information 112 from locations 102 to display 106 for viewing by a user.

A proposed reallocation of stock levels of the first product to the first best seller location from at least one location, other than the first best seller location, of the plurality of locations is displayed at step 240. For example, engine 104 may send a proposed reallocation of stock levels from reallocation module 116 to display 106 for verification by a user.

The proposed reallocation of the first product is ordered at step 250. For example, ordering module 118 may be place an order for a proposed reallocation of stock levels from reallocation module 116 shown on display 106 once a user has verified the reallocation and made any desired modifications via user interface 108.

The method 200 of FIG. 2 may further be used with a plurality of products. In such a case, each product may have one or more different best seller locations and be reallocated from different locations to its respective best seller location(s).

Referring to FIG. 3, a method 300, according to one exemplary embodiment, for performing a reallocation based on a slow seller location is illustrated. A stock level information for a plurality of locations for a first product is obtained at step 310. For example, engine 104 may retrieve stock information 112 from locations 102.

A first slow seller location for the first product from the plurality of locations is determined at step 320. For example, ranking module 114 may determine a slow seller location between locations 102 based on received historical sales information 110 from locations 102.

The received stock level information is displayed for the plurality of locations for the first product at step 330. For example, engine 104 may send received stock information 112 from locations 102 to display 106 for viewing by a user.

A proposed reallocation of stock levels of the first product from the first slow seller location to at least one location, other than the first slow seller location, of the plurality of locations is displayed at step 340. For example, engine 104 may send a proposed reallocation of stock levels from reallocation module 116 to display 106 for verification by a user.

The proposed reallocation of the first product is ordered at step 350. For example, ordering module 118 may be place an order for a proposed reallocation of stock levels from reallocation module 116 shown on display 106 once a user has verified the reallocation and made any desired modifications via user interface 108.

The method 300 of FIG. 3 may further be used with a plurality of products. In such a case, each product may have one or more different slow seller locations and be reallocated to different locations.

Referring to FIG. 4, a method 400, according to one exemplary embodiment, for performing a reallocation based on a best seller location and a slow seller location is illustrated. A stock level information for a plurality of locations for a first product and a second product is obtained at step 410. For example, engine 104 may retrieve stock information 112 from locations 102.

A first best seller location for the first product from the plurality of locations is determined at step 420. For example, ranking module 114 may determine a best seller location for a first product between locations 102 based on received historical sales information 110 from locations 102.

A first slow seller location for the second product from the plurality of locations is determined at step 430. For example, ranking module 114 may determine a slow seller location for a second product between locations 102 based on received historical sales information 110 from locations 102.

The received stock level information is displayed for the plurality of locations for the first product at step 440. For example, engine 104 may send received stock information 112 from locations 102 to display 106 for viewing by a user.

A proposed reallocation of stock levels of the first product to the first best seller location from at least one location, other than the first best seller location, of the plurality of locations and a proposed reallocation of stock levels of the second product from the first slow seller location to at least one location, other than the first slow seller location, of the plurality of locations is displayed at step 450. For example, engine 104 may send a proposed reallocation of stock levels for multiple products based on both best and slow selling locations between locations 102 from reallocation module 116 to display 106 for verification by a user.

The proposed reallocation of the first and second products is ordered at step 460. For example, ordering module 118 may be place an order for a proposed reallocation of stock levels for locations 102 from reallocation module 116 shown on display 106 once a user has verified the reallocation and made any desired modifications via user interface 108.

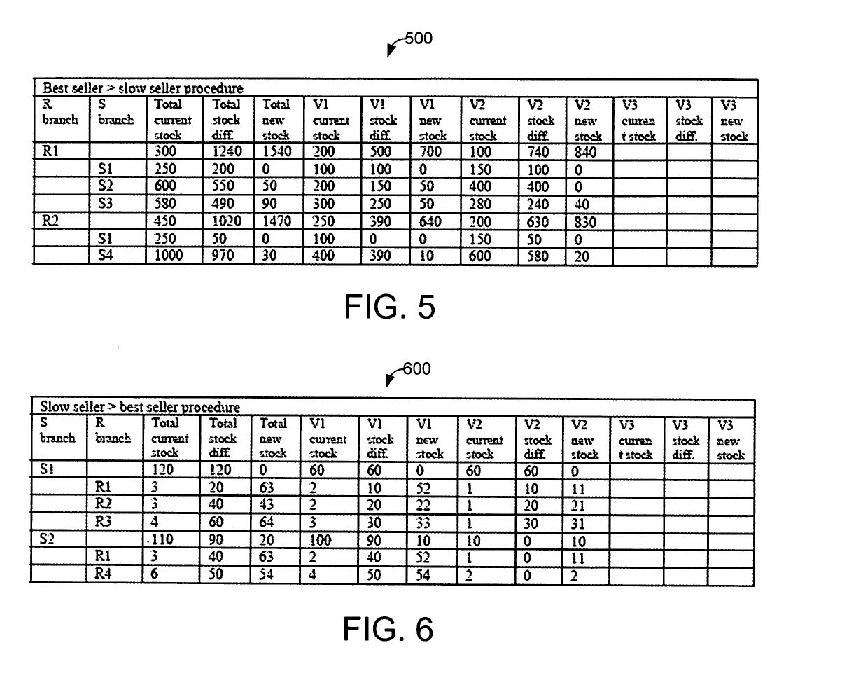

Referring to FIG. 5 and 6, further examples of stock level management from multiple slow seller locations to a single best seller location (FIG. 5) and from a single slow seller location to multiple best seller locations (FIG. 6) are shown in table format. Note that variables beginning with the letter “R” indicate receiving locations or branches, variables beginning with the letter “S” indicate sending locations or branches, and variables beginning with the letter “V” indicate different products to be reallocated.

Referring specifically to a table 500 of FIG. 5, by way of example, stock levels of a product V1 are reallocated from multiple sending or slow seller locations S1, S2, and S3 to a receiving or best selling location R1. Location R1 has an initial stock of product V1 of 200 pieces, while S1 includes 100 pieces, S2 200 pieces, and S3 300 pieces. Engine 104 determines that 100 pieces from location S1, 150 pieces from location S2, and 250 pieces from location S3 should be reallocated to location R1. Thus location R1 has a new stock of product V1 of 700 pieces while location S1 now has 0 pieces and locations S2 and S3 each have 50 pieces.

Referring specifically to a table 600 of FIG. 6, by way of example, stock levels of a product V2 are reallocated from one slow seller location S1 to multiple receiving or best selling locations R1, R2, and R3. Location S1 has an initial stock of product V2 of 60 pieces, while locations R1, R2, and R3 each include 1 piece. Engine 104 determines that 60 pieces from location S1 should be reallocated to other locations with 10 pieces being reallocated to location R1, 20 pieces to location R2, and 30 pieces to location R3. Thus location S1 has a new stock of product V1 of 0 pieces while location R1 now has 11 pieces, R2 has 21 pieces, and R3 has 31 pieces.

While not every example in the tables of FIGS. 5 and 6 have been discussed, note that the form of the examples described above is essentially the same for the other examples given. It is also noted that while not explicitly shown in the examples of FIGS. 5 and 6, methods have been contemplated and examples do exist where stock management system 100 simultaneously reallocates stock of a product from a single slow seller to multiple best sellers and from multiple slow sellers to a single best seller.

It is important to note that the construction and arrangement of the stock management system as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present inventions as expressed in the appended claims.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the diagrams herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software implementations of the present invention could be accomplished with standard programming techniques with rule based logic and other logic to accomplish the various connection steps, processing steps, comparison steps and decision steps.

What is claimed is:

1. A computer-implemented method of managing stock levels, comprising:
obtaining stock level information for a plurality of locations for a first product;
determining a first best seller location for the first product from the plurality of locations;
displaying the stock level information for the plurality of locations for the first product;
displaying a proposed reallocation of stock levels of the first product to the first best seller location from at least one location, other than the first best seller location, of the plurality of locations; and
ordering the proposed reallocation of the first product.

2. The computer-implemented method of claim 1, further comprising:
enabling modifications to the displayed proposed reallocation of stock levels;
wherein the act of ordering the proposed reallocation involves ordering the proposed reallocation including any modifications.

3. The computer-implemented method of claim 2, further comprising preventing retail store locations from the act of enabling modifications.

4. The computer-implemented method of claim 2, wherein the act of determining a first best seller determines the first best seller by obtaining historical sales information for the plurality of locations.

5. The computer-implemented method of claim 2, wherein the act of determining a first best seller determines the first best seller by comparing previous stock level information for the plurality of locations to more recent stock level information for the plurality of locations.

6. The computer-implemented method of claim 1, further comprising:
obtaining stock level information for the plurality of locations for a second product;
determining a second best seller location for the second product from the plurality of locations;
displaying the stock level information for the plurality of locations for the second product;
displaying a proposed reallocation of stock levels of the second product to the second best seller location from at least one location, other than the second best seller location, of the plurality of locations; and
ordering the proposed reallocation of the second product.

7. The computer-implemented method of claim 1, further comprising:
determining a first slow seller location for the first product from the plurality of locations;
displaying a proposed reallocation of stock levels of the first product from the first slow seller location to at least one location, other than the first slow seller location, of the plurality of locations; and
ordering the proposed reallocation of the first product from the first slow seller location.

8. The computer-implemented method of claim 1, further comprising restricting access by retail store locations to displayed information.

9. A computer-implemented method of managing stock levels, comprising:
obtaining stock level information for a plurality of locations for a first product;
determining a first slow seller location for the first product from the plurality of locations;
displaying the stock level information for the plurality of locations for the first product;
displaying a proposed reallocation of stock levels of the first product from the first slow seller location to at least one location, other than the first slow seller location, of the plurality of locations; and
ordering the proposed reallocation of the first product.

10. The computer-implemented method of claim 9, further comprising:
enabling modifications to the displayed proposed reallocation of stock levels;
wherein the act of ordering the proposed reallocation involves ordering the proposed reallocation including any modifications.

11. The computer-implemented method of claim 10, further comprising preventing retail store locations from the act of enabling modifications.

12. The computer-implemented method of claim 10, wherein the act of determining a first slow seller determines the first slow seller by obtaining historical sales information for the plurality of locations.

13. The computer-implemented method of claim 10, wherein the act of determining a first slow seller determines the first slow seller by comparing previous stock level information for the plurality of locations to more recent stock level information for the plurality of locations.

14. The computer-implemented method of claim 9, further comprising:
obtaining stock level information for the plurality of locations for a second product;
determining a second slow seller location for the second product from the plurality of locations;
displaying the stock level information for the plurality of locations for the second product;
displaying a proposed reallocation of stock levels of the second product to the second slow seller location from at least one location, other than the second slow seller location, of the plurality of locations; and
ordering the proposed reallocation of the second product.

15. The computer-implemented method of claim 9, further comprising restricting access by retail store locations to displayed information.

16. A computer-readable medium for use with an electronic device, the medium having instructions executable using the electronic device for performing a method of managing stock levels, comprising:
obtaining stock level information for a plurality of locations for a first product;
determining a first best seller location for the first product from the plurality of locations;
displaying the stock level information for the plurality of locations for the first product;
displaying a proposed reallocation of stock levels of the first product to the first best seller location from at least one location, other than the first best seller location, of the plurality of locations; and
ordering the proposed reallocation of the first product.

17. The computer-implemented medium of claim 16, wherein the method further comprises:
enabling modifications to the displayed proposed reallocation of stock levels;
wherein the act of ordering the proposed reallocation involves ordering the proposed reallocation including any modifications.

18. The computer-implemented medium of claim 16, wherein the method further comprises preventing retail store locations from the act of enabling modifications.

19. A computer-readable medium for use with an electronic device, the medium having instructions executable using the electronic device for performing a method of managing stock levels, comprising:
obtaining stock level information for a plurality of locations for a first product;
determining a first slow seller location for the first product from the plurality of locations;
displaying the stock level information for the plurality of locations for the first product;
displaying a proposed reallocation of stock levels of the first product from the first slow seller location to at least one location, other than the first slow seller location, of the plurality of locations; and
ordering the proposed reallocation of the first product.

20. The computer-implemented medium of claim 19, wherein the method further comprises:
enabling modifications to the displayed proposed reallocation of stock levels;
wherein the act of ordering the proposed reallocation involves ordering the proposed reallocation including any modifications.

21. The computer-implemented medium of claim 19, wherein the method further comprises preventing retail store locations from the act of enabling modifications.
